(19) United States
(12) Patent Application Publication
(10) Pub. No.: US 2019/0344314 A1
(43) Pub. Date: Nov. 14, 2019

(54) FIXTURE FLUSH APPARATUS AND METHOD

(71) Applicant: Louis Ray, Oakland, CA (US)

(72) Inventor: Louis Ray, Oakland, CA (US)

(21) Appl. No.: 16/521,410

(22) Filed: Jul. 24, 2019

Related U.S. Application Data
(63) Continuation of application No. 14/981,841, filed on Dec. 28, 2015.

(51) Int. Cl. B08B 9/032; E03C 1/04

(52) U.S. Cl. CPC B08B 9/0321; E03C 1/04

(57) ABSTRACT

A fixture flush system and method. The fixture flush system includes a first fastening end attached to a water faucet spout. A second fastening end is attached to a water supply line to facilitate reverse flow through the faucet and hot or cold water supply lines.

### BACKGROUND OF THE INVENTION

The present invention relates generally to mechanical fixtures systems methods, and more specifically to mechanical fixtures systems and methods for dislodging blockages or unclogging water faucets.

Water faucets can be important as they provide a necessary fluid flow and control of water into many of our homes and commercial establishments. However, after prolonged use, water faucets can become clogged by debris and other materials. In particular, rust in many older pipes can clog up the faucet, or the hot or cold water supply line or angle stop underneath.

A clogged water faucet will often disallow the flow of water, or any water that comes out from such a faucet is under extremely low pressure and will run slowly, drip or not run at all. A homeowner or other user experiencing the clogged faucet will often call a plumber to rectify the situation.

Often, plumbers can be expensive even for just a house visit. The plumber upon arrival will often evaluate the water faucet and sometimes determine that the water faucet needs to be replaced. The plumber would then need to order a new faucet. Because many homes and commercial establishments have multiple bathroom and kitchen faucets, it is cost prohibitive to purchase a single faucet, much less multiple new faucets.

In any event, upon delivery of the new faucet, the old one is removed and then disposed of typically in a landfill, a practice that is ecologically unsound and detrimental to the environment.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a fixture flush system, method and apparatus can be found in exemplary embodiments of the present invention.

The system includes a first fastener having a first diameter. A second fastener has a second diameter that is smaller than the first diameter. A central bore extends between the first fastener and the second fastener. The first fastener is connected to a spout of a faucet and the second fastener is connected to a water supply line. The central bore passes water from the water supply line in a reverse direction through the central bore and the spout and faucet and attached hot or cold water supply lines.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a fixture flushing system according to an exemplary embodiment of the present invention.

FIG. 2 illustrates a close-up perspective view of the fixture flush member of FIG. 1 according to an exemplary embodiment of the present invention.

FIG. 3 illustrates a close-up perspective view of the fixture flush member of FIG. 1 with the first fastening member on a surface according to an exemplary embodiment of the present invention.

FIG. 4 illustrates a plan view of the fixture flush member of FIG. 1 according to an exemplary embodiment of the present invention.

FIG. 5 illustrates a cross section of the fixture flush member of FIG. 1 according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the one embodiment, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

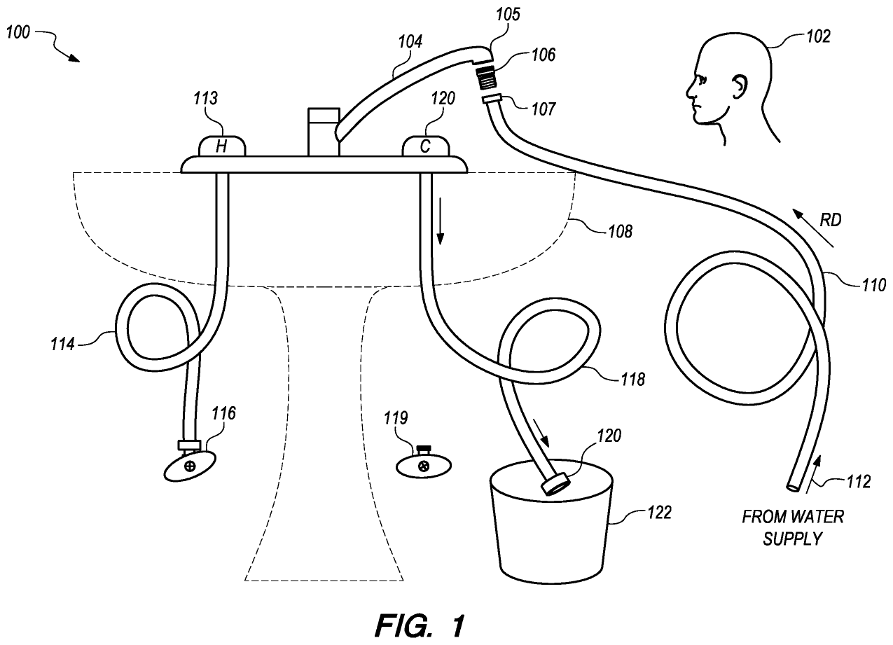

FIG. 1 illustrates fixture flushing system 100 according to an exemplary embodiment of the present invention.

In FIG. 1, fixture flushing system 100 is adapted to remove debris and other contaminants from faucets such as faucet 104 and the like. As shown in FIG. 1, faucet 104 might be a kitchen faucet or bathroom faucet that provides water for washing or rinsing in sink 108.

In FIG. 1, fixture flushing system 100 comprises a fixture flush member 106 configured to cooperatively and detachedly attach to spout 105 of faucet 104. Fixture flush member 106 is also configured to cooperatively attach to a fixture flush hose 110 via a standard hose thread 107. Fixture flush hose 110 is itself connected to a water supply 112.

As shown in FIG. 1, fixture flushing system 100 also includes a hot water supply hose 114 that is detachedly coupled to a left angle stop 116. Although not shown, left angle stop 116 includes a valve that controls the supply of hot water to faucet 104.

Fixture flushing system 100 further comprises a cold water supply hose 118 which is itself at one end connected to cold water knob 120 of faucet 104. Hot water supply hose 114 is also connected to hot water knob 113 of faucet 104.

As shown, fixture flushing system 100 further comprises right angle stop 119 to which cold water supply hose 118 is typically connected.

In use, a user 102 employs fixture flush member 106 to engage spout 105 cooperatively. The other end of fixture flush member 106 is then engaged with standard hose thread 107 of fixture flush hose 110. User 102 also disconnects cold water supply hose 118 from right angle stop 119 and places the disconnected end 120 into a bucket 122.

User 102 then turns on water supply 112 in a reverse direction from the direction of typical flow of the water supply, that is, the water flows into the spout through the faucet thereby clearing rust, contaminants, debris and all other such blockage inducing matter and flushes such contaminants through the cold water supply hose 118 into bucket 122. Arrow RD in FIG. 1. shows the backflow of water in the reverse direction.

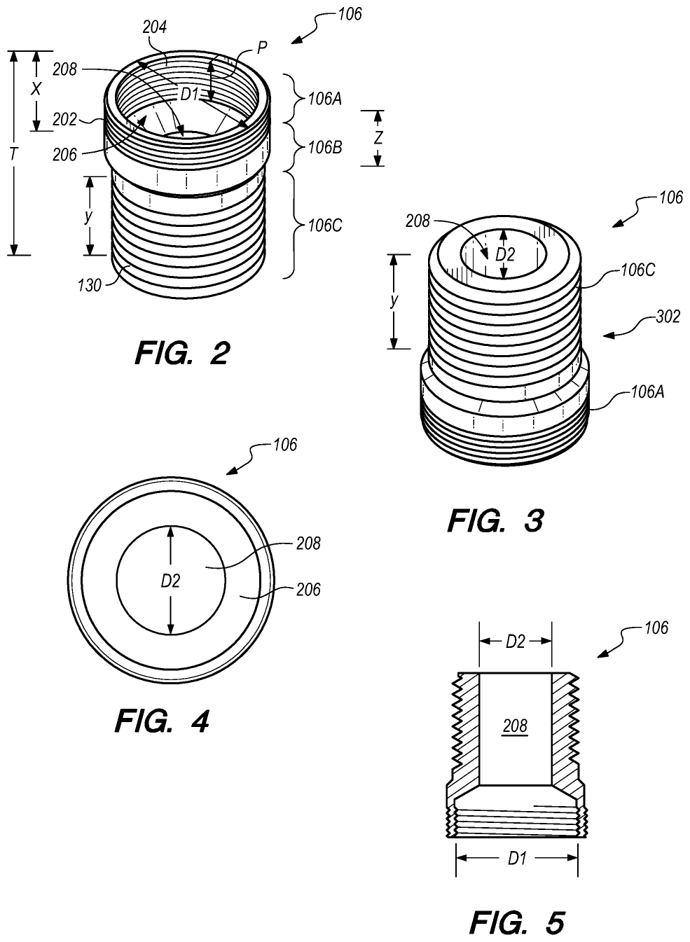

FIG. 2 illustrates a close-up perspective view of fixture flush member 106 of FIG. 1 according to an exemplary embodiment of the present invention.

As shown in FIG. 2, in this embodiment, fixture flush member 106 is a generally funnel-shaped apparatus or connector adapted to engage a faucet and a water supply source. Specifically, fixture flush member 106 comprises a first fastening member 106A and a second fastening member 106C. A central bore 208 extends internally between the first fastening member 106A and the third fastening member 106C, and a body member 106B also connects the fastening members.

Fastening member 106A fastens to and is configured to engage the spout of a faucet (typically kitchen or bathroom) and remain cooperatively engaged therewith. As shown, fastening member 106A is circular shaped having an opening or aperture 206. The interior of aperture 206 comprises an internal female thread 204 while the exterior of fastening member 106A includes an upper male thread 202.

An advantage of the present invention is that either upper male thread 202 or female thread 204 may be used to fasten fixture flush member 106 onto the spout of a faucet. Upper male thread 202 is utilized when spout 105 (of FIG. 1) includes a female thread (not shown). In this manner, upper male thread 202 can mate with the female thread (not shown) of spout 105 to engage the faucet therewith. Preferably, upper male thread 202 is 15/16 inches-27 male and is adapted to mate with a corresponding female thread (not shown) of spout 105.

In some embodiments, note that the female (or male) thread of spout may become accessible only after the aerator is removed. Such an aerator is typically positioned on the tip of spout 105 to control water flow and save water. Thus, in FIG. 1, spout 105 is depicted without the aerator.

Referring to FIG. 2, female thread 204 of fastening member 106A is employed when spout 105 includes a male thread that can mate with female thread 204 so as to cooperatively engage fixture flush member 106 and spout 105 of faucet 104. Female thread 204 is preferably 55/64 inches-27 and is adapted to mate with a corresponding-sized male thread of spout 105.

In FIG. 2, preferably, the length Y of female thread 204 is 0.2035 inches. Similarly, the preferable length X of upper male thread 202 is 0.2035 inches. The total length T of fixture flush member 106 is 1.1 inches. Also, in FIG. 2, the preferable axial diameter D1 of aperture 206 is 15/16 inches-27. One skilled in the art will understand that the stated dimensions are preferable but exemplary. Other suitable dimensions may be utilized.

In FIG. 2, as noted, fixture flush member 106 of the present embodiment also includes fastening member 106C (see FIG. 3 also). Fastening member 106C fastens to and is configured to engage the standard female thread of a water supply hose or line. Fastening member 106C is also circular-shaped having an opening (not shown) for the central bore 208 discussed below. The exterior of fastening member 106C includes a lower male thread 130 that couples with and is configured to engage with a standard female thread (not shown) of the water supply hose. Note that the fastening members may be connectors, fittings or the like. Preferably, the length J of fastening member 106C is 0.6435 inches, although it is noted that this length J is exemplary and one skilled in the art could use any length that is consistent with the spirit and scope of the present invention.

As noted above, fixture flush member 106 also comprises body member 106B. Body member 106B couples fastening member 106A and fastening member 106C, extending from immediately below upper male thread 202 to the beginning of fastening member 106C. Preferably, the length Z of body member 106B is 0.26 inches.

Internally, body member 106B is funnel shaped, extends initially straight downwardly from immediately below internal female thread 204 and then begins to slope until it reaches central bore 208. In this manner, by sloping the interior of body member 106B, a funnel shape is created that funnels water between the larger sized aperture 206 and the smaller sized central bore 208.

Body member 106B also facilitates holding of fixture flush member 106 in the hand and allows the flush member to be rotated clockwise or counter clockwise into either spout 105 or a standard thread of the water supply line. However, in another embodiment, body member 106B is not incorporated. Fastening member 106A can be directly coupled to fastening member 106C, with the bottom of upper male thread 202 and the top of lower male thread 130 being planar and coupled to each other.

In FIG. 2, fixture flush member 106 further comprises central bore 208 that passes water from fixture flush hose 110 and faucet 104. In this embodiment, as the name implies, central bore 208 is a cylindrical bore or tubular passageway that extends through fastening member 106C to aperture 206.

Specifically, central bore 208 begins from below female thread 204 and extends downwardly through fastening member 106C as shown in FIG. 2 and FIG. 4. As seen in FIG. 4, central bore 208 has a diameter D2 that is preferably 0.5 inches. Thus, the diameter D2 on one end of the fixture flush member 106 is smaller than the diameter D1 of aperture 206 on the end.

The enlarged end of the funnel shape of fixture flush member 106 is at the first fastening member 106A end, and the reduced end of the funnel is at the 106C fastening member end. Central bore 208 facilitates the flow of water from a water supply line cooperatively attached to fastening member 106C, wherein water is received from the water line, via the fastening member 106C end through central bore 208 and egresses at aperture 206 into faucet 104 via spout 105.

The water from the water supply line flushes any contaminants, debris or the like in a reverse direction from the water supply line through central bore 208 and then through spout 105 through cold water supply hose 118 (FIG. 1) and through and into bucket 122 of FIG. 1.

In this manner, the present advantage is the ability to allow user 102 (a homeowner or plumber) to dislodge debris and remove contaminants from faucets (kitchen faucets or bathroom faucets) and allow such debris to be back flushed where it is collected in bucket 122. Note that user 102 may also remove hot water supply hose 114 from left angle stop 116 for placement (not shown) in bucket 122. Water can then be back-flowed from fixture flush hose 110 through faucet 104 and hot water supply hose 114 into bucket 122.

FIG. 5 is a side plan view of fixture flush member 106. Central bore 208 is depicted. As can be seen, the axial diameter D1 of aperture 206 is larger than the axial diameter D2 of central bore 208. In this manner, fastening member 106A, having aperture 206, can be connected to a corresponding sized spout 105 while fastening member 106C, can be connected to a water supply line, typically, via a standard connector having a female 20 thread such as a water hose.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A system comprising:
a flush member to flush a faucet with lodged debris, the flush member having a first and a second cylindrical fastener, wherein the first cylindrical fastener is to insert into an interior of a spout of the faucet with lodged debris, wherein the first cylindrical fastener has a first central bore with a first diameter and wherein the first cylindrical fastener has first male threads around an external periphery of the first cylindrical fastener, wherein the second cylindrical fastener is to insert into a standard hose of a water supply line, wherein said second cylindrical fastener has a second central bore with a second diameter that is less than the first diameter, wherein the second cylindrical fastener has second male threads around an external periphery of the second cylindrical fastener, wherein the first cylindrical fastener and the second cylindrical fastener are in a concentric relationship with the first cylindrical fastener positioned over the second cylindrical fastener so that the first cylindrical fastener and the second cylindrical fastener share a common central axis; and
a funnel-shaped interior body member connecting the first cylindrical fastener and the second cylindrical fastener, the funnel-shaped interior body member having an interior wall surface extending from a longitudinal interior wall surface of the first central bore and sloping to a longitudinal interior wall surface of the second central bore, said first central bore and said second central bore to pass water in a reverse direction from the standard hose through the first and second central bores to the faucet to dislodge said lodged debris from the faucet through an outlet other than the spout.

2. The system of claim 1 wherein the interior wall surface of the first central bore initially extends straight downwardly before sloping to the longitudinal interior wall surface of the second central bore.

3. The system of claim 1 wherein the interior wall surface of the funnel-shaped interior body member is threadless.

4. The system of claim 1 further comprising a threadless area on the flush member, wherein said threadless area is between said first male threads around the exterior periphery of the first cylindrical fastener and said second male threads around the exterior periphery of the second cylindrical fastener.

5. The system of claim 1 wherein said outlet is a cold water supply line coupled to a rear of the faucet.

6. A system to flush contaminants from inside of a faucet, the system comprising:
a first cylindrical connector with first male threads around an exterior periphery of the first cylindrical connector, wherein the first male threads are to insert into a corresponding female threads in an interior of a spout of said faucet, wherein the first cylindrical connector includes a first central bore with a first diameter;
a second cylindrical connector with second male threads around an exterior periphery of the second cylindrical connector, wherein the second male threads are to insert into corresponding female threads in an interior of a standard hose of a water supply line, wherein said second cylindrical connector includes a second central bore with a second diameter smaller than the first diameter, wherein said first cylindrical connector is positioned above said second cylindrical connector; and
a funnel-shaped interior body member connecting the first cylindrical connector and said second cylindrical connector, the funnel-shaped interior body member having an interior wall surface that extends from an interior wall surface of the first central bore to an interior wall surface of the second central bore, said first central bore and said second central bore to pass water in a reverse direction from the standard hose through the first central bore, and the second central bore to the faucet to dislodge the contaminants from within the faucet.

7. The system of claim 6 wherein the contaminants are dislodged through an outlet other than the spout, wherein the outlet is coupled to a rear of said faucet.

8. The system of claim 6 further comprising a flush member having the first cylindrical connector and the second cylindrical connector, wherein the first male thread and the second male threads are at oppositely disposed ends of the flush member.

9. The system of claim 6 further comprising a cold water supply line coupled to a rear of the faucet, the cold water supply line to flush water with the contaminants in a direction opposite to a direction for supplying water to the faucet.

10. The system of claim 6 wherein said first and second central bores passing water in the reverse direction are to flush out debris from the faucet via a cold or hot water supply connected to a rear of the faucet.

11. A method comprising:
coupling a flush member to a faucet with lodged debris, the flush member having a first and a second tubular connector, wherein the first tubular connector has a first central bore with a first diameter, the first tubular connector having first threads, wherein said second tubular connector has a second central bore with a second diameter smaller than the first diameter, wherein the second tubular connector includes second threads, wherein said coupling is by connecting the first threads to a spout of the faucet with lodged debris, wherein the first tubular fastener and the second tubular fastener are positioned to share the same center, wherein the flush member includes a funnel-shaped interior body member connecting the first tubular connector and said second tubular connector, the funnel-shaped interior body member having an interior wall surface that slopes from a longitudinal interior wall surface of the first central bore to a longitudinal interior wall surface of the second central bore;
coupling the second threads to a standard hose of a water supply line;
disconnecting a hot or cold water supply line that is coupled to the rear of the faucet for supplying hot or cold water to the faucet;
passing water in a reverse direction from through the faucet, wherein the water is passed from the standard hose of the water supply line through the first tubular connector, the second tubular connector to the spout of the faucet; and
flushing out the lodged debris from the interior of the faucet, through the hot or cold water supply line that is disconnected.

12. The method of claim 11 wherein the interior wall surface of the funnel-shaped interior body member initially extends straight downwardly before sloping to the longitudinal interior wall surface of the second central bore.

13. The method of claim 11 wherein the interior wall surface of the funnel-shaped interior body member is threadless.

14. The method of claim 11 wherein the hot or cold water supply line is disconnected from an ankle stop.

15. The method of claim 11 further comprising placing the disconnected hot or cold water supply line in a receptacle to collect the debris.

16. A method comprising:
providing a first tubular connector with first male threads around an exterior periphery of the first tubular connector, wherein the first male threads is to insert into a corresponding female threads in an interior of a spout of a faucet having debris lodged within an interior of the faucet, wherein the first tubular connector includes a first central bore with a first diameter;
providing a second tubular connector with second male threads around an exterior periphery of the second tubular connector, the second male threads are to insert into corresponding female threads in an interior of a standard hose of a water supply line, wherein said second tubular connector includes a second central bore with a second diameter smaller than the first diameter; wherein the first tubular connector is positioned above said second tubular connector; and
providing a funnel-shaped interior body member connecting the first tubular connector and said second tubular connector, the funnel-shaped interior body member having an interior wall surface that extends from a longitudinal interior wall surface of the first central bore to a longitudinal interior wall surface of the second central bore, said first central bore and said second central bore to pass water in a reverse direction from the standard hose through the first and second central bores and the faucet to dislodge the contaminants from within the faucet to an outlet other than the spout, the outlet being at a rear of said faucet.

17. The method of claim 16 further comprising providing a flush member having the first tubular connector and the second tubular connector, wherein the first male thread and the second male threads are at oppositely disposed ends of the flush member.

18. The method of claim 16 wherein the interior wall surface of the funnel-shaped interior body member initially extends straight downwardly before sloping to the longitudinal interior wall surface of the second central bore.
